(19) United States
(12) Patent Application Publication
(10) Pub. No.: US 2008/0012717 A1
(43) Pub. Date: Jan. 17, 2008

(54) Memory device capable of displaying available memory space thereof

(75) Inventor: Xiao-Zhu Chen, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/309,922

(22) Filed: Oct. 27, 2006

(30) Foreign Application Priority Data
Jul. 14, 2006 (CN) 200610061642.8

(51) Int. Cl. G08B 21/00

(52) U.S. Cl. 340/653

(57) ABSTRACT

A memory device capable of displaying available and used memory space thereof includes an interface configured to connect with an electronic device, an interface control unit, a microprogrammed control unit (MCU), a memory configured for communicating with the electronic devices under control of the MCU, and a display unit. The MCU is electrically coupled to the interface via the interface control unit. The memory and the display are both electrically coupled to the MCU. The MCU receives data from the memory and controls the display unit to show an amount of available and used memory space of the memory.

### FIELD OF THE INVENTION

The present invention relates to memory devices, and more particularly, to a memory device which can display available and used memory space thereof.

### DESCRIPTION OF RELATED ART

With the development of the technologies of computers, memory devices, such as universal serial bus (USB) flash disks, external hard disk drives, and storage severs, are now in widespread use. These memory devices enable users to save data conveniently therein. However, these memory devices need to use software and a display of a computer to measure and show used or available memory space thereof, which is not convenient for users. For example, when users need to know an amount of used or available memory space of a storage server, they must use a computer, which is very inconvenient.

What is desired, therefore, is to provide a memory device which can conveniently display an amount of available and used memory space thereof.

### SUMMARY OF THE INVENTION

An exemplary memory device capable of displaying an amount of available and used memory space thereof includes an interface configured to connect with an external electronic device, an interface control unit, a microprogrammed control unit (MCU), a memory configured for communicating with the electronic devices under control of the MCU, and a display unit. The MCU is electrically coupled to the interface via the interface control unit. The memory and the display are both electrically coupled to the MCU. The MCU receives data from the memory and controls the display unit to show an amount of available and used memory space of the memory.

Other advantages and novel features will become more apparent from the following detailed description when taken in conjunction with the accompanying drawings, in which:

### BRIEF DESCRIPTION OF THE DRAWINGS

FIG. 1 is a schematic view of a memory device in accordance with a first preferred embodiment of the present invention;

FIG. 2 is a circuit block diagram of FIG. 1; and

FIG. 3 is a schematic view of a memory device in accordance with a second preferred embodiment of the present invention.

### DETAILED DESCRIPTION OF THE INVENTION

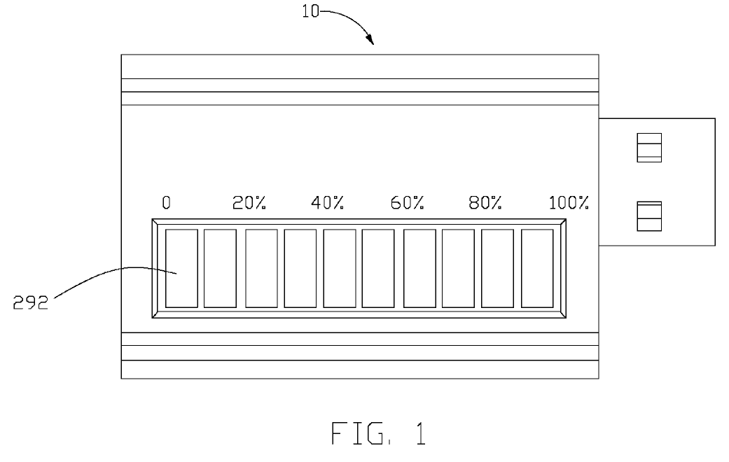

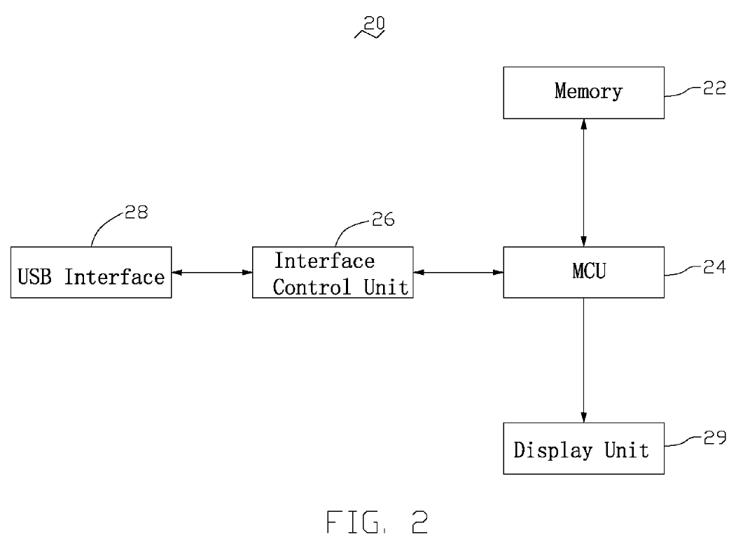

Referring to FIGS. 1 and 2, a memory device in accordance with a first preferred embodiment of the present invention is shown. In this embodiment, the memory device is a universal serial bus (USB) flash disk 10. The USB flash disk 10 includes a memory 12, a microprogrammed control unit (MCU) 14, an interface control unit 16, a USB interface 18, and a display unit 19. The display unit 19 includes ten light-emitting diodes (LEDs) 192 therein. An amount of the LEDs 192 can be arranged according to need.

The USB interface 18 is electrically coupled to the MCU 14 via the interface control unit 16. The memory 12 is electrically coupled to the MCU 14, and communicated with electronic devices, such as computers by the USB interface 18, the interface control unit 16, and the MCU 14. The display unit 19 is electrically coupled to the MCU 14, and the MCU 14 controls the display unit 19 to display an amount of available and used memory space of the memory 12.

In this embodiment, the ten LEDs 192 of the display unit 19 are arranged on a surface of the USB flash disk 10 in a row. A plurality of labels, such as 0, 20%, 40%, 60%, 80%, 100% are attached to the surface of the USB flash disk 10 near the ten LEDs 192 for indicating a percentage of the memory space of the memory 12 currently in use (which also indicates that percentage of memory space not in use). A program of the MCU 14 satisfies that: when all of the memory of memory 12 is free, the ten LEDs 192 are turned off; when an amount of the memory space of the memory 12 in use is between 0 and 10%, the first LED 192 lights up; and when the amount of the memory space of the memory 12 in use is between 10% and 20%, the first and second LEDs 192 light up, and so on up to 100% of the memory space of the memory 12 is in use when all 10 LEDs are lit. This embodiment allows display of an approximate percentage of available and used memory of the memory 12. Where, lit LEDs reflect used memory space and unlit LEDs reflect available memory space. In other embodiments, the number of lit LEDs 192 indicates a percentage of available memory. If the LEDs 192 are replaced by a plurality of digital displays, and the program of the MCU 14 is amended for the digital displays, the digital displays can precisely indicate either the percentage or amount of the available and used memory space of the memory 12.

The USB flash disk 10 can receive power from a computer through the USB interface 18 being plugged into a USB port of the computer. At this time, the MCU 14 reads data of the memory 12 and calculates an amount of the available and used memory space of the memory 12, and controls the display unit 19 to show the percentage of available and used memory space of the memory 12 via the ten LEDs 192, which is very convenient. In addition, the USB flash disk 10 also can receive power from a battery arranged therein.

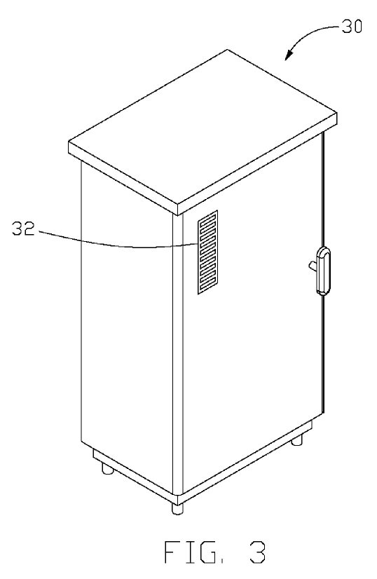

Referring also to FIG. 3, a memory device in accordance with a second preferred embodiment of the present invention is shown. In this embodiment, the memory device is a storage server 20. The storage server 20 includes a memory, an MCU, an interface control unit, and a display unit 22 like those of the first embodiment. Circuit connections of the second preferred embodiment are similar to that of the first preferred embodiment, except that in place of the USB interface 18 a network interface is provided. The display unit 22 is arranged on a front panel of the storage server 20 for showing a percentage or amount of available and used memory space of the memory thereof. Typically, the storage server 20 is placed on an appointed place, the display unit 22 can show the available and used memory space of the memory of the storage server 20 in real time, which is convenient since no other devices such as a computer are needed.

It is to be understood, however, that even though numerous characteristics and advantages of the preferred embodiments have been set forth in the foregoing description, together with details of the structures and functions of the embodiments, the disclosure is illustrative only, and changes may be made in detail, especially in matters of shape, size, equivalent material and arrangement of parts within the principles of the invention to the full extent indicated by the broad general meaning of the terms in which the appended claims are expressed.

What is claimed is:

1. A memory device comprising:
an interface configured to electrically connect with an external electronic devices;
an interface control unit;
a microprogrammed control unit (MCU) electrically coupled to the interface via the interface control unit;
a memory electrically coupled to the MCU configured for communicating with the electronic devices under control of the MCU; and
a display unit electrically coupled to the MCU, the MCU being capable of controlling the display unit to show an amount of available and used memory space of the memory.

2. The memory device as claimed in claim 1, wherein the display unit includes a plurality of light-emitting diodes (LEDs), the MCU controls the LEDs to indicate the amount of available and used memory space of the memory.

3. The memory device as claimed in claim 2, wherein an amount of the LEDs is ten.

4. The memory device as claimed in claim 2, wherein the LEDs are arranged on a surface of the memory device in a row.

5. The memory device as claimed in claim 1, wherein the display unit includes a plurality of digital displays, the MCU controls the digital displays to indicate the amount of available and used memory space of the memory.

6. The memory device as claimed in claim 1, wherein the interface is a universal serial bus (USB) interface.

7. A storage server having an available and used memory space display function, comprising:
a microprogrammed control unit (MCU);
a memory; and
a display unit electrically coupled to the memory via the MCU, the MCU receiving data from the memory and controlling the display unit to show an amount of available and used memory space of the memory.

8. The storage server as claimed in claim 7, wherein the display unit includes a plurality of light-emitting diodes (LEDs), the MCU controls the LEDs to indicate the amount of available and used memory space of the memory.

9. The storage server device as claimed in claim 8, wherein an amount of the LEDs is ten.

10. The storage server device as claimed in claim 8, wherein the LEDs are arranged on a front panel of the storage server.

11. The storage server device as claimed in claim 7, wherein the display unit includes a plurality of digital displays, the MCU controls the digital displays to indicate the amount of available and used memory space of the memory.

12. A storage device comprising:
a memory configured for storaging data;
an interface configured to connect with an external electronic devices to allow the memory communicating with the electronic device;
an interface control unit coupled to the interface;
a microprogrammed control unit (MCU) coupled between the memory and the interface control for controlling the memory and calculating an amount of available and used memory space of the memory; and
a display unit electrically coupled to the MCU for displaying the amount of available and used memory space of the memory.

13. The storage device as claimed in claim 12, wherein the display unit comprises a plurality of light-emitting diodes (LEDs) with labels mounted therearound, and the MCU is capable of a controlling the LEDs to indicate the amount of available and used memory space of the memory.

14. The storage device as claimed in claim 13, wherein the LEDs are arranged on an exterior surface of the storage device.

15. The storage device as claimed in claim 12, wherein the display unit includes a plurality of digital displays, and the MCU is capable of controlling the digital displays to indicate the amount of available and used memory space of the memory.

16. The storage device as claimed in claim 12, wherein the interface is a universal serial bus (USB) interface.

17. The storage device as claimed in claim 12, wherein the interface is network interface.
